(19) United States
(12) Patent Application Publication
(10) Pub. No.: US 2011/0254540 A1
(43) Pub. Date: Oct. 20, 2011

(54) Micro-Magnetic Sensor for Acceleration, Position, Tilt, and Vibration

(76) Inventor: Xu Hua Jiang, San Jose, CA (US)

(21) Appl. No.: 12/819,193

(22) Filed: Jun. 19, 2010

(30) Foreign Application Priority Data
Apr. 16, 2010 (CN) 201020160586.5

(51) Int. Cl. G01B 7/14

(52) U.S. Cl. 324/207.15

(57) ABSTRACT

A micro-magnetic based sensor and a system built with it for detecting or measuring acceleration, speed, position, placement, tilt, and vibration are disclosed for a reduced product size, simplified manufacturing process, and reduced product cost. Both micro-magnetic sensor and micro-magnetic system include a primary micro inductor and a secondary micro inductor coupled with a micro magnetically permeable dynamic medium element that is small, simple and low cost to manufacture.

### CROSS REFERENCE TO RELATED APPLICATIONS

This patent application is based upon and claims the priority of a previously filed pending China patent application of Application Number 201020160586.5 and filing date of Apr. 16, 2010 by Xu Hua Jiang whose content is herein incorporated by reference for any and all purposes.

### FIELD OF INVENTION

This invention relates generally to the field of sensors for acceleration, displacement, tilt, or vibration, aka accelerometers, by generating electronic signal variation corresponding to position variation and speed variation. More specifically, the present invention is directed to a technique and associated device structure capable of detecting acceleration, position, tilt, and vibration of a matter.

### BACKGROUND OF THE INVENTION

Known prior arts of magnetic field sensors include the Hall-effect sensor and the electro dynamic transducer. The manufacturing process of Hall-effect sensors is complicated and costly. Due to its required large sizes, it is not practical to scale the electro dynamic transducers down into micro electromechanical system (MEMS) like semiconductor dimensions as desired by many modern electronic products and systems.

### SUMMARY OF THE INVENTION

A micro magnetic sensor (MMS) for acceleration, displacement, tilt, and vibration is proposed. The MMS includes:
a). A primary winding with two input terminals.
b). A secondary winding with two differential output terminals.
c). A magnetically permeable dynamic medium element (MPDME) placed near both the primary winding and the secondary winding so as to effect a transformer coupling between them.
d). An external single frequency drive signal source connected to the primary input terminals.
   As a result, the MMS generates a phase-based differential output signal (PDOS) that responds to an MPDME movement due to a motion such as acceleration, position variation, tilt variation, or vibration.

In an embodiment, the MPDME further includes:
a). A sealed nonmetallic coil tube enclosed by both the primary winding and the secondary winding but insulated from them.
b). A composite sensor core disposed inside the coil tube for a free sliding movement along its axis under an inertial force. The composite sensor core is made of two identical magnetic medium end elements, namely movable magnetic medium A (MMM-A) and movable magnetic medium B (MMM-B), bonded together via an intervening interface element (IIE).

In a more specific embodiment, the IIE is made of a non-magnetic material or a material with a magnetic permeability different from that of the MMM-A and MMM-B.

In a more specific embodiment with the application of an external single frequency drive signal source, the primary winding is configured to enclose the coil tube along a virtual axis that passes through the two ends of the coil tube.

In a more specific embodiment with the generation of the PDOS, the secondary winding is configured to have two oppositely wound but otherwise identical sub-windings secondary sub-winding A (SSW-A) and secondary sub-winding B (SSW-B) symmetrically joined at a central winding point (CWP). The other free end of SSW-A defines a secondary differential output terminal one (SDOT-1) and the other free end of SSW-B defines a secondary differentia output terminal two SDOT-2. Like the primary winding, the secondary winding also encloses the coil tube along its virtual axis. The CWP is electrically floating. The absolute value of the generated PDOS is zero when the IIE is located at a central tube point (CTP) along the virtual axis.

In a more specific embodiment, the MPDME has a pair of identical balancing spring element A (BSE-A) and balancing spring element B (BSE-B), respectively attached to the ends of the composite sensor core and the coil tube for automatically returning the composite sensor core position to the CTP when there is no motion and the virtual axis is oriented perpendicular to the gravity axis.

In a more specific embodiment, the interior of coil tube is vacuum or filled with air, oil, or a liquid.

In another embodiment where a multi-axis micro magnetic sensor system (MA-MMS) is configured for simultaneously sensing a motion such as acceleration, position, tilt, and vibration along a number of directions respectively parallel to axes A₁, A₂, . . . , Aⱼ, . . . , A_{N} (N>1), the MA-MMS has N micro magnetic sensors (MMSⱼ, j=1, 2, . . . , N) for sensing a motion such as acceleration, position variation, tilt variation, or vibration along respective axes A₁, . . . , A_{N}, where, except for the orientation of its individual virtual axis, the internal structure of each MMSⱼ is the same or similar to the MMS as described above.

In a more specific embodiment of MA-MMS where N=3, the axes A₁, A₂, A₃ correspond respectively to X-axis, Y-axis, Z-axis of a Cartesian coordinate system.

In another embodiment where a digital micro magnetic sensor system (DMMSS) for sensing a motion such as acceleration, position variation, tilt variation, or vibration is built with:
a). An MMS.
b). A serially connected bridge circuit (BGC) with its input terminals connected to the SDOT-1 and SDOT-2.
c). A signal amplifier (SGA) with its input terminals connected to the output terminals of BGC.
d). A mixed signal post-processor (MSPP) that is built with:
   i). A serially connected analog signal filter (ASF).
   ii). An analog-to-digital converter (ADC) that converts the analog output signal of the ASF to a digital signal. And
   iii). A digital signal processor (DSP) that receives the output of ADC together with a digital control input and processes the digital signal to generate a digital sensor signal output (DSSO).
With an external single frequency drive signal source applied to the primary input terminals, the DMMSS generates, through the DSP, the DSSO corresponding to a motion such as acceleration, position variation, tilt variation, or vibration of the composite sensor core.

These aspects of the present invention and their numerous embodiments are further made apparent, in the remainder of the present description, to those of ordinary skill in the art.

### BRIEF DESCRIPTION OF THE DRAWINGS

In order to more fully describe numerous embodiments of the present invention, reference is made to the accompanying drawings. However, these drawings are not to be considered limitations in the scope of the invention, but are merely illustrative:

FIG. 1 is a schematic illustration of a micro-magnetic sensor element for sensing a motion such as acceleration, position variation, tile variation, or vibration;

FIG. 2 illustrates a basic micro-magnetic sensor system with a signal amplifier connected via a bridge circuit to the micro-magnetic sensor element of FIG. 1;

FIG. 3 illustrates a single-axis digital micro-magnetic sensor system built with the basic micro-magnetic sensor of FIG. 2 followed by a mixed-signal post-processor; and

FIG. 4 illustrates a multi-axis digital micro-magnetic sensor system with a tri-axis digital micro-magnetic sensor system using the present invention embodiments already illustrated in FIG. 1, FIG. 2 and FIG. 3 for sensing acceleration, position, tile, and vibration.

### DETAILED DESCRIPTION OF SPECIFIC EMBODIMENTS

The description above and below plus the drawings contained herein merely focus on one or more currently preferred embodiments of the present invention and also describe some exemplary optional features and/or alternative embodiments. The description and drawings are presented for the purpose of illustration and, as such, are not limitations of the present invention. Thus, those of ordinary skill in the art would readily recognize variations, modifications, and alternatives. Such variations, modifications and alternatives should be understood to be also within the scope of the present invention.

For the purpose of simplifying manufacturing process, reducing cost, and achieving the external dimensions of MEMS semiconductors, the present invention provides a method of using a micro-magnetic sensor that generates, by balancing a coil tube's phase floating point, a synchronously varying electronic signal corresponding to a motion such as position variation, acceleration, or vibration of an object that carries the micro-magnetic sensor.

The present invention proposes the placement, inside a non-metallic coil tube, of two pieces of cylinders (or cubes, or cuboids, or elliptic cylinders) of equal magnetic permeability joined via a non-magnetic material or a material with different magnetic permeability from that of the two pieces of cylinders. The magnetically permeable material can be made of iron, steel, or other magnetically permeable material. The joined length is shorter than the coil tube's interior length for a free movement between the ends of the coil tube. The ends of the coil tube are closed with each end connected to a spring or a springy element of the same spring constant and the same length. The interior of the tube can be vacuum or filled with air, or liquid. Surrounding the exterior of the coil tube are a primary winding and a secondary winding with surface insulation, such as copper wires coated with paint. The primary winding is a single-section winding helically surrounding the coil tube in either one direction along the tube axis. The secondary winding has two sections of sub-windings having the same number of turns but opposite winding direction. The starting terminals of the two sub-windings are connected together at a central winding point (CWP) that is not grounded. Thus, the ending terminals of the two sub-windings form a pair of symmetric output terminals. For application, a single frequency periodic drive signal is applied to the terminals of the primary winding. Correspondingly, the sensor outputs an electronic signal via the two ending terminals of the secondary winding.

While the coil tube is stationary with its axis oriented parallel to the ground surface, the non-magnetic material joining the two cylinders of equal magnetic permeability is located at the mid point along the coil tube axis with the absolute value of the phase differential electronic signal across the two ending terminals approaches zero. However, under a dynamic state of motion or while the coil tube is oriented perpendicular to the ground surface, such as while the combined matter inside the coil tube is going through acceleration, position variation, or gravity effect, the two ending terminals of the secondary winding would output an absolute phase differential electronic signal that is non-zero.

The two ending terminals of the secondary winding are connected to a bridge circuit sequentially followed by an amplifier, a filter, an analog to digital converter, and a digital signal processor in series. In this way, a digital micro-magnetic sensor for acceleration, displacement, tilt, and/or vibration is formed.

The benefit of present invention includes having two units of the same sensor share the same input driving signal source. The two coil tubes (of the two sensor units) are oriented perpendicular to each other forming an X-Axis and a Y-Axis. During operation, the thus formed sensor outputs two phase differential electronic signals corresponding respectively to the motion dynamics along X-Axis and Y-Axis. Similarly, by having three identical sensors oriented orthogonally with one another and share the same input driving signal source motion dynamics along X, Y, and Z Axes can be sensed among three mutually perpendicular coil tubes. The thus formed sensor would output three phase differential electronic signals corresponding respectively to X, Y and Z Axis. More specifically, while the coil tubes are going through motion dynamics, the sensor can obtain, through the digital signal microprocessor, digital signals of acceleration, tilt, displacement, and vibration. As examples of application, the thus obtained digital signals can be used in dynamic state control systems, navigation systems, anti-theft systems, fitness equipments, robotic sensors, and electronic gaming machines' dynamic operating systems. This sensor is also structurally simple.

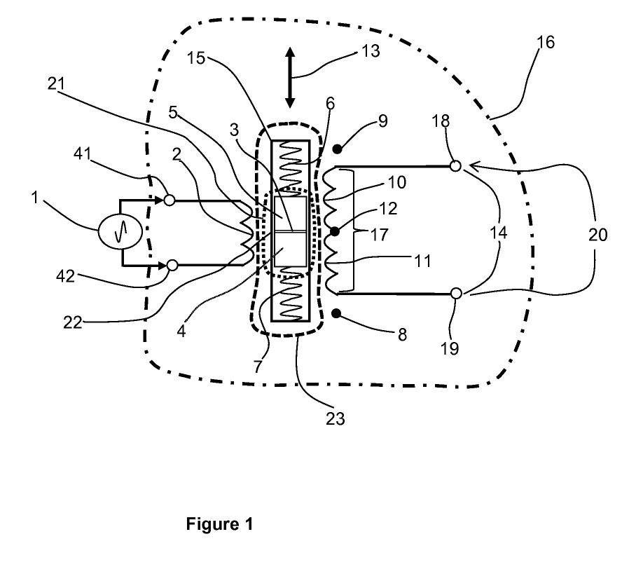

FIG. 1 is a schematic illustration of a micro magnetic sensor (MMS) 16 for acceleration, displacement, tilt, and vibration. The MMS 16 includes: a primary winding 2, serving as the master inductor, and a secondary winding 17, serving as the slave inductor. The primary winding 2 has primary input terminal 1 41 and primary input terminal 2 42 both connected to an External single frequency drive signal source 1. The secondary winding 17 further includes two oppositely wound but otherwise identical secondary sub-winding A (SSW-A) 10 and secondary sub-winding B (SSW-B) 11. They are joined at a Central Winding Point (CWP) 12 and are wound with secondary differential output terminal 1 (SDOT-1) 18 and secondary differential output terminal 2 (SDOT-2) 19. As another part of the MMS 16, a magnetically permeable dynamic media element (MPDME) 23 is placed near primary winding 2 and secondary winding 17. In an embodiment, the MPDME 23 can simply be a central core enclosed by the primary winding 2 and further enclosed by SSW-A 10 and SSW-B 11 sharing the MPDME 23 as a magnetic medium for electro-magnetic coupling. Upon connecting the External single frequency drive signal source 1 to primary input terminals 41 and 42, a phase-based differential output signal (PDOS) 20 is generated between SDOT-1 18 and SDOT-2 19 at a Secondary Winding Output port 14. Consequently, upon a movement of a Composite Sensor Core 21 of the MPDME 23, the MMS 16 generates a corresponding PDOS 20 at the Secondary Winding Output port 14.

The MPDME 23 includes: a sealed nonmetallic Coil Tube 15 surrounded by primary winding 2 and further surrounded by both SSW-A 10 and SSW-B 11, and a Composite Sensor Core 21 disposed inside the Coil Tube 15 for a free sliding movement along its axis direction as illustrated by movable direction of Composite Sensor Core 13 under an inertial force. The Composite Sensor Core 21 is made of a movable magnetic medium A (MMM-A) 5 and a movable magnetic medium B (MMM-B) 4, bonded together via an intervening interface element (IIE) 3. MMM-A 5 and MMM-B 4 have identical geometry and equal magnetic permeability with a magnetic permeability value MP-AB. The IIE 3 can be made of either a non-magnetic material or a magnetically permeable material with a magnetic permeability value MP-C, where MP-C is different from MP-AB.

The primary winding 2 is centered with respect to the Composite Sensor Core 21 along the movable direction of Composite Sensor Core 13. Likewise, the SSW-A 10 and SSW-B 11 are centered with respect to the Composite Sensor Core 21 along the movable direction of Composite Sensor Core 13 as well. That is, SSW-A 10 and SSW-B 11 are symmetrically connected via the central winding point (CWP) 12. Other than the winding directions, the detailed winding geometries, including wire gauge, coil diameter, coil pitch and number of turns, of SSW-A 10 and SSW-B 11 are configured to be the same. Additionally, magnetic Pole 1 8 of the SSW-A 10 and magnetic Pole 1 9 of the SSW-B 11 are placed symmetric with respect to the CWP 12 as well. Thus magnetic Pole 1 8 defines a Secondary Differential Output Terminal 2 (SDOT-2) 19 while magnetic Pole 1 9 defines a Secondary Differential Output Terminal 1 (SDOT-1) 18. The CWP 12 is electrically floating. As a result, the absolute value of the Phase-based Differential Output Signal (PDOS) 20 approaches zero while IIE 3 stays balanced at the central tube point (CTP) 22 that is located at the center along the axis of coil tube 15.

The MPDME 23 further includes a pair of identical balancing spring element A (BSE-A) 6 and balancing spring element B (BSE-B) 7 respectively attached to the ends of Composite Sensor Core 21 and coil tube 15. The BSE-A 6 and BSE-B 7 are made with equal axial length and spring constant to balance, under either a weak compression force or a weak expansion force, the IIE 3 at the CTP 22 in a static environment. In other words, the pair of BSE-A 6 and BSE-B 7 would automatically return the position of IIE 3 to CTP 22 when there is no motion and when the movable direction of Composite Sensor Core 13 is oriented perpendicular to the gravity axis or direction.

The interior of coil tube 15 can be vacuum or filled with air, oil or a liquid.

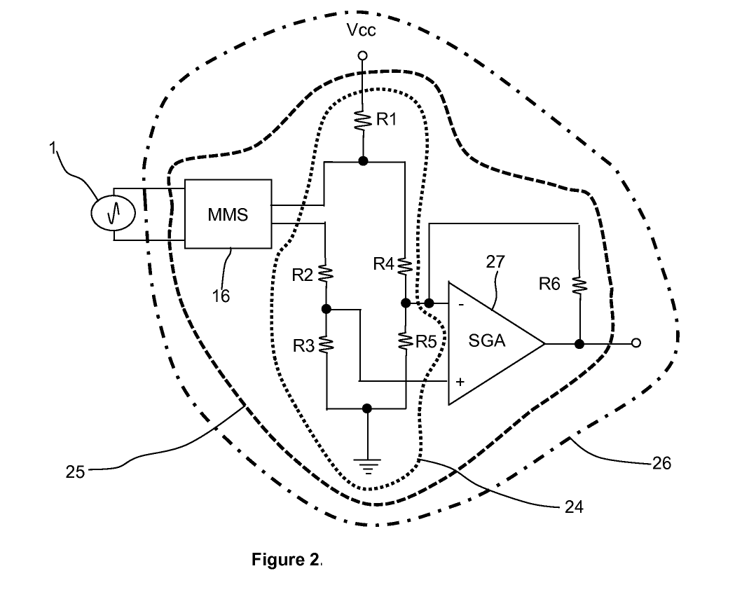

FIG. 2 illustrates a basic micro-magnetic sensor system (BMMSS) 26 of acceleration, displacement, tilt, and/or vibration using the present invention MMS 16 connected to a signal amplifier (SGA) 27 via a resistive bridge circuit (BGC) 24 powered by a supply voltage Vcc. The BGC 24 includes resistor elements R1-R5. With this circuitry, the PDOS 20 is converted into another differential signal with a ground reference then amplified for further signal processing. For convenience, the collection of MMS 16 together with the circuitry is called Micro Magnetic Sensor Head (MMSH) 25.

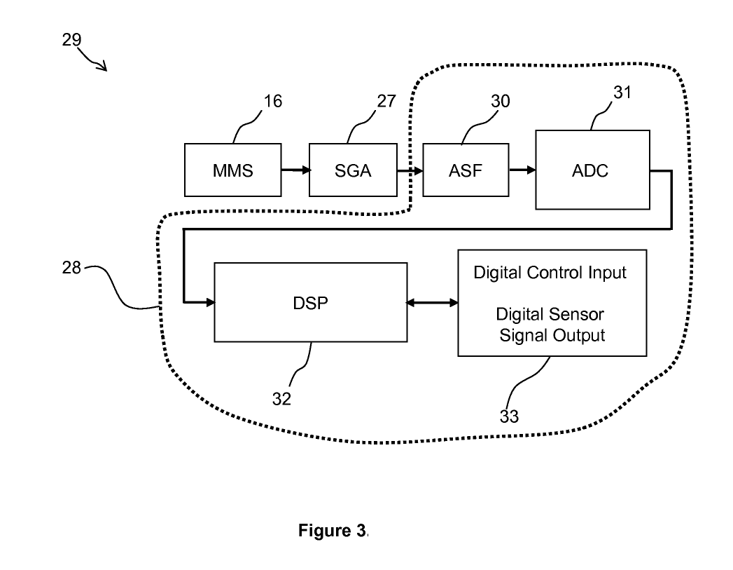

FIG. 3 illustrates a single-axis digital micro-magnetic sensor system 29 built with the basic MMS 16 connected to an SGA 27 (BGC 24 is omitted here for simplicity of illustration) of FIG. 2 followed by a mixed-signal post-processor (MSPP) 28. The MSPP 28 has a serial connection of an analog signal filter (ASF) 30, an analog to digital converter (ADC) 31, a digital signal processor (DSP) 32, and a digital input/output interface 33 including a Digital Control Input and a Digital Sensor Signal Output. The ASF 30 filters out band noises. The ADC 31 converts filtered analog sensor output signal to a digital format to be processed by DSP 32 for communication to human or other devices/processors via the digital input/output interface 33.

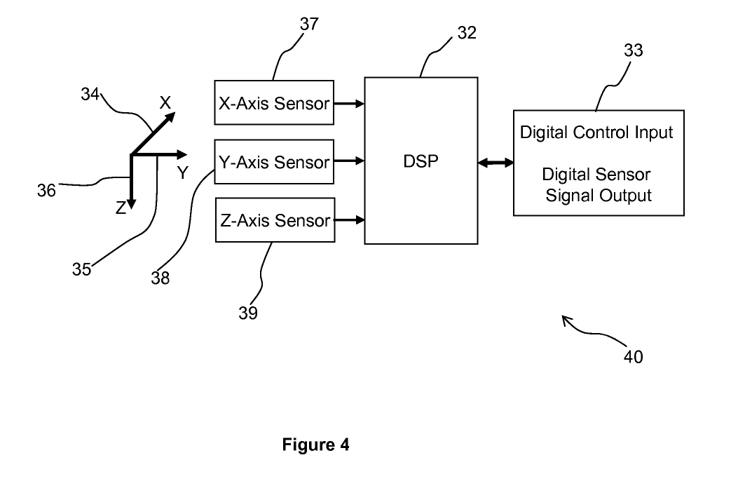

FIG. 4 illustrates a special case of a multi-axis (axes A₁, A₂, . . . , Aⱼ, . . . A_{N} where N>1) digital micro magnetic sensor system (MA-MMS) 40 for simultaneously sensing acceleration, displacement, tilt, and vibration via a tri-axis digital micro-magnetic sensor system using the present invention illustrated in FIG. 1, FIG. 2, and FIG. 3, for sensing acceleration, position, tile, and vibration. Within this tri-axis sensor system, an X-Axis Sensor 37 represents a single-axis micro-magnetic sensor system having an MMS 16, followed by BGC 24, SGA 27, ASF 30, and ADC 31. Likewise, a Y-Axis Sensor 38 and a Z-Axis Sensor 39 are the same as the X-Axis Sensor 37 except that the X-Axis 34, Y-Axis 35, and Z-Axis 36 are dimensionally perpendicular to one another forming a Cartesian coordinate system. The digital output signals from X-Axis Sensor 37, Y-Axis Sensor 38, and Z-Axis Sensor 39 are received by a DSP 32 that communicates with human or other devices/processors via a Digital Control Input & Digital Sensor Signal Output interface 33 for digital signal processing of acceleration, displacement, tilt, and/or vibration.

Throughout the description and drawings, numerous exemplary embodiments were given with reference to specific configurations. It will be appreciated by those of ordinary skill in the art that the present invention can be embodied in numerous other specific forms and those of ordinary skill in the art would be able to practice such other embodiments without undue experimentation. For example, although this application describes a single-axis and a tri-axis micro-magnetic sensor systems for acceleration, position, tilt, and vibration, the invention is equally applicable for measuring the speed of a matter and is expandable into a general multi-axis micro-magnetic sensor system for physical measurement such as acceleration, speed, displacement, position, tilt, and vibration. The scope of the present invention, for the purpose of the present patent document, is hence not limited merely to the specific exemplary embodiments of the foregoing description, but rather is indicated by the following claims. Any and all modifications that come within the meaning and range of equivalents within the claims are intended to be considered as being embraced within the spirit and scope of the present invention.

What is claimed are:

1. A micro magnetic sensor (MMS) for acceleration, position, tilt, and vibration comprising:
a primary winding and a secondary winding wherein the primary winding has two primary input terminals and the secondary winding is wound with two secondary differential output terminals SDOT-1 and SDOT-2; and
a magnetically permeable dynamic media element (MPDME) placed near both the primary winding and the secondary winding so as to effect a transformer coupling there between in that, upon connecting the primary input terminals to an external single frequency drive signal source, a phase-based differential output signal PDOS is generated between SDOT-1 and SDOT-2 and, upon a movement of the MPDME due to acceleration, position, tilt or vibration, the MPDME causes a corresponding response of the PDOS.

2. The MMS of claim 1 wherein the MPDME comprises:
a sealed nonmetallic coil tube enclosed by both the primary winding and the secondary winding but insulated there from; and
a composite sensor core, disposed inside the coil tube for a free sliding movement along its axis under an inertial force, made of two magnetically permeable end elements MPEE-A and MPEE-B bonded together via an intervening interface element (IIE), said MPEE-A and MPEE-B having matched geometry and magnetic permeability of a first magnetic permeability value MP-AB whereas said IIE having a second magnetic permeability MP-C unequal to MP-AB
whereby the MPDME causes a corresponding response of the PDOS through a movement of the composite sensor core.

3. The MMS of claim 2 wherein the IIE is made of a magnetically non-permeable material.

4. The MMS of claim 2 wherein:
the primary winding is centered along the axis of coil tube; and
the secondary winding comprises two secondary sub-windings SSW-a and SSW-b with matched winding geometry joined at a central winding point (CWP) thus defining the SDOT-1 and SDOT-2, wherein the CWP being electronically floating, the winding geometry of SSW-a and SSW-b being, referencing the CWP, symmetric with respect to each other such that the absolute value of PDOS approaches zero while the IIE stays balanced at a central tube point (CTP) located at the center of the coil tube axis.

5. The MMS of claim 4 wherein the MPDME further comprises a pair of balancing spring elements BSE-A and BSE-B, of equal axial length and spring constant, respectively attached to the ends of the composite sensor core and coil tube to balance, under either a weak compression force or a weak expansion force, the IIE at the CTP in a static environment.

6. The MMS of claim 5 wherein the interior of coil tube is vacuum or filled with air, oil or a liquid.

7. A multi-axis micro magnetic sensor (MA-MMS) for simultaneously sensing acceleration, position, tilt, and vibration along a plurality of directions respectively parallel to axes A₁, A₂, . . . , Aⱼ, . . . , A_{N} with N>1, the MA-MMS comprises N micro magnetic sensors (MMSⱼ, j=1, 2, . . . , N) for respectively sensing acceleration, position, tilt, and vibration along axes A₁, . . . , A_{N}, wherein each MMSⱼ comprises:
a sealed nonmetallic coil tube oriented parallel to axis Aⱼ;
a composite sensor core, disposed inside the coil tube for a free sliding movement along axis Aⱼ under an inertial force, made of two magnetically permeable end elements MPEE-A and MPEE-B bonded together via an intervening interface element (IIE), said MPEE-A and MPEE-B having matched geometry and magnetic permeability of a first magnetic permeability value MP-AB whereas said IIE having a second magnetic permeability MP-C unequal to MP-AB; and
a primary winding and a secondary winding both enclosing the coil tube for a transformer coupling there between, wherein the primary winding has two primary input terminals and the secondary winding is wound with two secondary differential output terminals SDOT-1 and SDOT-2 such that:
upon connecting the set of primary input terminals from (MMS₁, . . . , MMS_{N}) to a common external single frequency drive signal source, the MA-MMS simultaneously generates a corresponding set of phase-based differential output signals (PDOSⱼ, j=1, 2, . . . N) with each PDOSⱼ developed between SDOT-1 and SDOT-2 of MMSⱼ, responsive to the acceleration, position, tilt, and vibration of the set of composite sensor cores of the MA-MMS.

8. The MA-MMS of claim 7 wherein N=3 and the axes A₁, A₂, A₃ correspond respectively to X-axis, Y-axis, Z-axis of a Cartesian coordinate system.

9. A digital micro magnetic sensor system (DMMSS) for sensing acceleration, position, tilt, and vibration, the DMMSS comprising:
a micro magnetic sensor head (MMSH) comprising:
a micro magnetic sensor for acceleration, position, tilt, and vibration (MMS) comprising:
a sealed nonmetallic coil tube;
a composite sensor core, disposed inside the coil tube for a free sliding movement along its axis under an inertial force, made of two magnetically permeable end elements MPEE-A and MPEE-B bonded together via an intervening interface element (IIE), said MPEE-A and MPEE-B having matched geometry and magnetic permeability of a first magnetic permeability value MP-AB whereas said IIE having a second magnetic permeability MP-C unequal to MP-AB; and
a primary winding and a secondary winding both enclosing the coil tube for a transformer coupling there between, wherein the primary winding has two primary input terminals and the secondary winding is wound with two secondary differential output terminals SDOT-1 and SDOT-2; and
a serially connected bridge circuit (BGC) and signal amplifier (SGA) with the input terminals of BGC connected to the SDOT-1 and SDOT-2; and
a mixed signal post-processor (MSPP) comprising:
a serially connected analog signal filter (ASF), analog-to-digital converter (ADC) and digital signal processor (DSP) with the ASF input connected to the SGA output such that:
upon connecting the primary input terminals to an external single frequency drive signal source, the DMMSS generates, through the DSP, a digital sensor output signal (DSOS) representing the acceleration, position, tilt, and vibration of the composite sensor core.

10. The DMMSS of claim 9 wherein:
the primary winding is centered along the axis of coil tube;
the secondary winding comprises two secondary sub-windings SSW-a and SSW-b with matched winding geometry joined at a central winding point (CWP) thus defining the SDOT-1 and SDOT-2, wherein the CWP being electrically floating, the winding geometry of SSW-a and SSW-b being, referencing the CWP, symmetric with respect to each other such that the absolute value of PDOS approaches zero while the IIE stays balanced at a central tube point (CTP) located at the center of the coil tube axis.

11. The DMMSS of claim 10 wherein the MMS further comprises a pair of balancing spring elements BSE-A and BSE-B, of equal axial length and spring constant, respectively attached to the ends of the composite sensor core and coil tube to balance, under either a weak compression force or a weak expansion force, the IIE at the CTP in a static environment.

12. The DMMSS of claim 11 wherein the interior of coil tube is vacuum or filled with air, oil or a liquid.
